(19) United States
(12) Patent Application Publication
(10) Pub. No.: US 2026/0326249 A1
(43) Pub. Date: Oct. 22, 2026

(54) COMPONENT PROCESSING SYSTEM AND CONTROL METHOD THEREFOR

(71) Applicant: TSINGHUA UNIVERSITY, Beijing (CN)

(72) Inventors: Fugui XIE, Beijing (CN); Xinjun LIU, Beijing (CN); Yuhao HE, Beijing (CN); Zenghui XIE, Beijing (CN)

(21) Appl. No.: 19/408,413

(22) Filed: Dec. 4, 2025

Related U.S. Application Data
(63) Continuation of application No. PCT/CN2024/077794, filed on Feb. 20, 2024.

(30) Foreign Application Priority Data
Jun. 5, 2023 (CN) 202310658035.3

(51) Int. Cl. B23Q 1/70; B23Q 3/06; B23Q 5/10; B23Q 5/40

(52) U.S. Cl. CPC B23Q 1/706; B23Q 3/06; B23Q 5/10; B23Q 5/40

(57) ABSTRACT

A component processing system and a control method therefor are provided. The component processing system includes: a positioning mechanism, a processing mechanism. The positioning mechanism includes a positioning base a first transverse moving member a longitudinal moving member, and a second transverse moving member The first transverse moving member is movably mounted at the base in a first transverse direction. The longitudinal moving member is movably mounted at the first transverse moving member in a longitudinal direction. The second transverse moving member is movably mounted at the longitudinal moving member in a second transverse direction. The processing mechanism includes a processing base a spindle assembly, and a pressing member The processing base is mounted at the second transverse moving member. The spindle assembly is movably connected to the processing base and configured to process a component.

### CROSS-REFERENCE TO RELATED APPLICATION

This application claims priority to Chinese Patent Application No. 202310658035.3 filed on Jun. 5, 2023 by Tsinghua University, the entire contents of which are incorporated herein by reference.

### FIELD

The present disclosure relates to the field of advanced manufacturing technologies, and more particularly, to a component processing system and a control method therefor.

### BACKGROUND

The rapid development of fields such as aerospace, energy and power, and transportation has put forward higher requirements for the processing of large components. Large components are characterized by large dimensions, low rigidity, and free-form surfaces. In addition, some possess layered structures and hole-making requirements, posing severe challenges to processing devices in terms of processing range, operational complexity, processing efficiency, processing accuracy, etc.

In the related art, the processing mode for large components involves the use of large machine tools. However, the number of large machine tools and the processing resources they can provide are limited, making it difficult to meet the growing demand for multi-variety and small-batch processing. In addition, the large machine tools have high manufacturing costs, and their dimensions fail to be expanded indefinitely with the continuous increase in component dimensions to meet the processing requirements for large components.

### SUMMARY

The present disclosure aims to solve at least one of the technical problems in the related art. Therefore, an objective of the present disclosure is to provide a component processing system, which can meet requirements for high-quality local processing of large components.

Another objective of the present disclosure is to provide a control method for the above-described component processing system.

The component processing system according to embodiments of the present disclosure includes: a positioning mechanism, the positioning mechanism including a positioning base, a first transverse moving member, a longitudinal moving member, and a second transverse moving member, the first transverse moving member being movably mounted at the base in a first transverse direction, the longitudinal moving member being movably mounted at the first transverse moving member in a longitudinal direction, and the second transverse moving member being movably mounted at the longitudinal moving member in a second transverse direction, any two of the first transverse direction, the second transverse direction, and the longitudinal direction intersecting with each other; a processing mechanism, the processing mechanism including a processing base, a spindle assembly, and a pressing member, the processing base being mounted at the second transverse moving member, the spindle assembly being movably connected to the processing base and configured to process a component, the pressing member being movably connected to the processing base and configured to contact and engage with the component, the spindle assembly and the pressing member being capable of moving independently; and an auxiliary tooling located at a side of the positioning mechanism in the second transverse direction and configured to fix the component.

With the component processing system according to the embodiments of the present disclosure, the processing mechanism can achieve large-range movement in the first transverse direction, the longitudinal direction, and the second transverse direction through cooperation of the first transverse moving member, the longitudinal moving member, and the second transverse moving member, to meet processing requirements for components of various dimensions. In addition, independent movement of the pressing member and the spindle assembly can realize a wider range of operating modes, which is conducive to achieving high-quality local processing operations.

In addition, the component processing system according to the above-described embodiments of the present disclosure may also have the following additional technical features:

According to some embodiments of the present disclosure, the processing mechanism further includes: a first driving member mounted at the processing base, the first driving member including a first retractable portion, and the pressing member being provided with a first connection portion at an outer circumferential surface of the pressing member, the first retractable portion being connected to the first connection portion and configured to drive the pressing member to move axially; and a second driving member mounted at the processing base, the second driving member including a second retractable portion, and the spindle assembly being provided with a second connection portion at an outer circumferential surface of the spindle assembly, the second retractable portion being connected to the second connection portion to drive the spindle assembly to move axially.

According to some embodiments of the present disclosure, the second connection portion is disposed at an end portion of the first driving member close to the component. The pressing member is located at a side of the second connection portion facing towards the component. A spindle of the spindle assembly passes through the pressing member.

According to some embodiments of the present disclosure, the processing base includes a first base, a second base, and five branch chains. The first base is connected to the second transverse moving member. Each of the five branch chains is connected to the first base via a first hinge with two intersecting rotational axes. One of the five branch chains is connected to the second base via a second hinge, and each of the other four branch chains of the five branch chains is connected to the second base via a third hinge with two intersecting rotational axes. Each of the five branch chains includes a branch chain driving member connected to the first hinge and a branch chain lead screw connected to the second hinge. The branch chain driving member is threadedly engaged with the branch chain lead screw and configured to drive the branch chain lead screw to extend and retract axially.

According to some embodiments of the present disclosure, in an axial direction of the spindle assembly, five first hinges are located at a same level, the second hinge and two third hinges are located at a same level and connected to a lower part of the second base, and the other two third hinges are located at a same level and connected to an upper part of the second base.

According to some embodiments of the present disclosure, in a circumferential direction of the spindle assembly, the second hinge and the two third hinges are located at a lower level are evenly arranged at intervals, and the other two third hinges are located at a higher level, and each of the other two third hinges is located between the second hinge located at a higher level and the third hinge.

According to some embodiments of the present disclosure, the positioning base is provided with a first slide rail extending in the first transverse direction. The first slide rail is provided with two stop portions at two ends of the first slide rail in the first transverse direction, respectively. The first transverse moving member is provided with a first slide block at a bottom of the first transverse moving member. The first slide block is slidable along the first slide rail between the two stop portions.

According to some embodiments of the present disclosure, the first transverse moving member is provided with a mounting space extending in the longitudinal direction. The mounting space extends through the first transverse moving member in the second transverse direction. The first transverse moving member is provided with a second slide rail on at least one side of the first transverse moving member in the second transverse direction. The second slide rail extends in the longitudinal direction. The longitudinal moving member passes through the mounting space and being slidably engaged with the second slide rail via a second slide block. The first transverse moving member is provided with a first motor and a first lead screw. The first lead screw extends in the longitudinal direction and is threadedly engaged with the longitudinal moving member. The first motor is connected to the first lead screw and configured to drive the first lead screw to rotate. The first lead screw rotates to drive the longitudinal moving member to move in the longitudinal direction.

According to some embodiments of the present disclosure, the longitudinal moving member is provided with a third slide rail extending in the second transverse direction. The second transverse moving member is slidably engaged with the third slide rail via a third slide block. The longitudinal moving member is provided with a second motor and a second lead screw. The second lead screw extends in the second transverse direction and is threadedly engaged with the second transverse moving member. The second motor is connected to the second lead screw and configured to drive the second lead screw to rotate. The second lead screw rotates to drive the second transverse moving member to move in the second transverse direction.

According to some embodiments of the present disclosure, the auxiliary tooling and the positioning mechanism are arranged independently.

According to some embodiments of the present disclosure, the pressing member is provided with a plurality of distance detection members that are arranged at intervals in a circumferential direction of the pressing member and configured to detect a distance between the pressing member and the component. The spindle assembly is adapted to adjust an axial angle according to detection results of the plurality of distance detection members.

According to some embodiments of the present disclosure, three or more distance detection members are provided. The pressing member includes a conical surface at a surface of the pressing member facing towards the component. The three or more distance detection members are disposed at the conical surface.

A control method for the component processing system according to the embodiments of the present disclosure includes: mounting the component at the auxiliary tooling; controlling three-degree-of-freedom motion of the positioning mechanism, to position the spindle assembly of the processing mechanism opposite to the component; controlling the spindle assembly to move relative to the processing base, to align a spindle of the spindle assembly with a to-be-processed point of the component; controlling the pressing member to extend to press against a surface of the component; and controlling the spindle assembly to feed axially, to realize a processing operation on the component.

According to some embodiments of the present disclosure, the control method further includes, prior to controlling the pressing member to extend to press against the surface of the component: controlling the pressing member to extend and come into contact with the surface of the component; detecting a normal direction of the to-be-processed point; and controlling the pressing member to retract, and controlling the spindle assembly to move relative to the processing base, to allow an axial direction of the spindle assembly to coincide with the normal direction of the to-be-processed point, and allow the spindle to be aligned with the to-be-processed point.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become apparent and readily understood from the following description of embodiments in conjunction with the accompanying drawings, in which:

FIG. 1 is a schematic structural diagram of a component processing system according to an embodiment of the present disclosure.

FIG. 2 is a schematic structural diagram of a positioning base according to an embodiment of the present disclosure.

FIG. 3 is a schematic structural diagram of a first transverse moving member according to an embodiment of the present disclosure.

FIG. 4 is a schematic structural diagram of a longitudinal moving member according to an embodiment of the present disclosure.

FIG. 5 is a schematic structural diagram of a second transverse moving member according to an embodiment of the present disclosure.

FIG. 6 is a schematic partial structural diagram of a component processing system according to an embodiment of the present disclosure.

FIG. 7 is a schematic structural diagram of a processing component according to an embodiment of the present disclosure.

FIG. 8 is a schematic structural diagram of FIG. 7 from another perspective.

FIG. 9 is a schematic structural diagram of a first branch chain according to an embodiment of the present disclosure.

FIG. 10 is a schematic structural diagram of a second branch chain according to an embodiment of the present disclosure.

FIG. 11 is a schematic partial structural diagram of a processing component according to an embodiment of the present disclosure.

FIG. 12 is a schematic partial structural diagram of a processing component according to an embodiment of the present disclosure.

FIG. 13 is a schematic partial structural diagram of a processing component according to an embodiment of the present disclosure.

FIG. 14 is a schematic structural diagram of an auxiliary tooling according to an embodiment of the present disclosure.

FIG. 15 is a flowchart of a control method for a component processing system according to an embodiment of the present disclosure.

### REFERENCE NUMERALS

component processing system 100; positioning mechanism 10;
positioning base 11; first slide rail 111; first slide block 112; stop portion 113; shim 114; lightening hole 115;
first transverse moving member 12; mounting space 121; second slide rail 122; second slide block 123; first motor 124; first lead screw 125; motor bracket 126;
longitudinal moving member 13; third slide block 131; second motor 132; second lead screw 133; first nut 134; second nut 135;
second transverse moving member 14; third slide rail 141; base connection portion 142; processing mechanism 20;
processing base 21; first base 211; second base 212; first driving member 213; first retractable portion 214; second driving member 215; second retractable portion 216; fourth slide rail 217; fourth slide block 218;
spindle assembly 22; spindle 221; spindle motor 222; second connection portion 223;
pressing member 23; first connection portion 231; distance detection member 232;
first branch chain 24; second branch chain 25; third branch chain 26; fourth branch chain 27; fifth branch chain 28; first hinge 241; second hinge 242; branch chain driving member 243; branch chain lead screw 244; third hinge 251;
auxiliary tooling 30; component 40.

### DETAILED DESCRIPTION OF THE EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

In the description of the present disclosure, it should be understood that the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In the description of the present disclosure, the features associated with “first” and “second” may explicitly or implicitly include at least one of the features, and the term “plurality” means two or more. The first feature being “on” or “under” the second feature may include the first feature being in direct contact with the second feature, or the first feature being not in direct contact with the second feature, but being in contact with the second feature through another feature therebetween. The first feature being “above” the second feature includes the first feature being directly above or obliquely above the second feature, or simply means that a level of the first feature is higher than a level of the second feature.

In some related art, the processing method for large components involves the use of large machine tools. However, the number of large machine tools and the processing resources they can provide are limited, and their manufacturing costs are high, making it impossible to adapt to the growing demand for multi-variety and small-batch processing of large components.

To this end, the present disclosure provides a component processing system capable of large-range movement and local precision processing, to achieve high-quality local cutting of large components.

The component processing system 100 according to the embodiments of the present disclosure is described below with reference to the accompanying drawings.

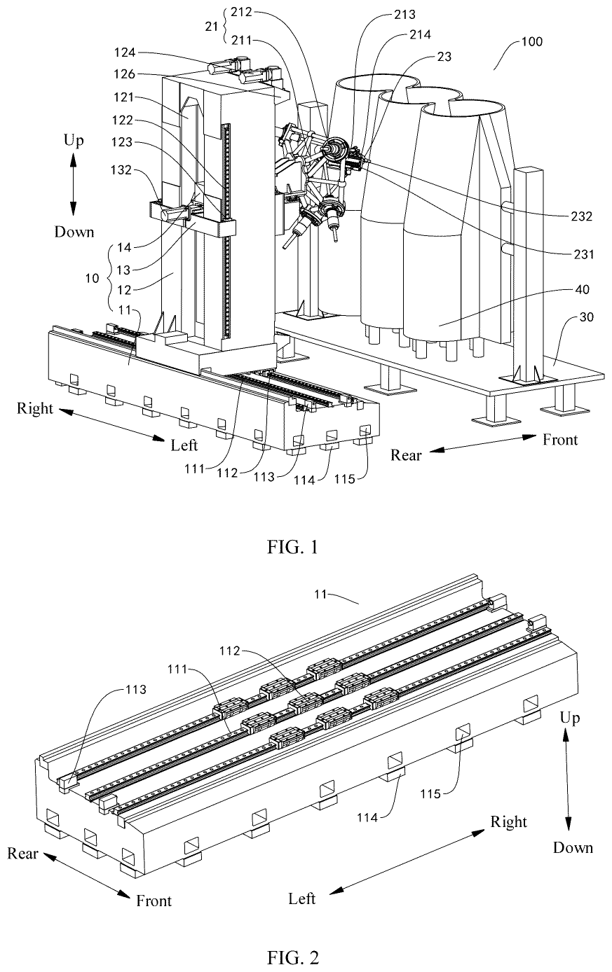

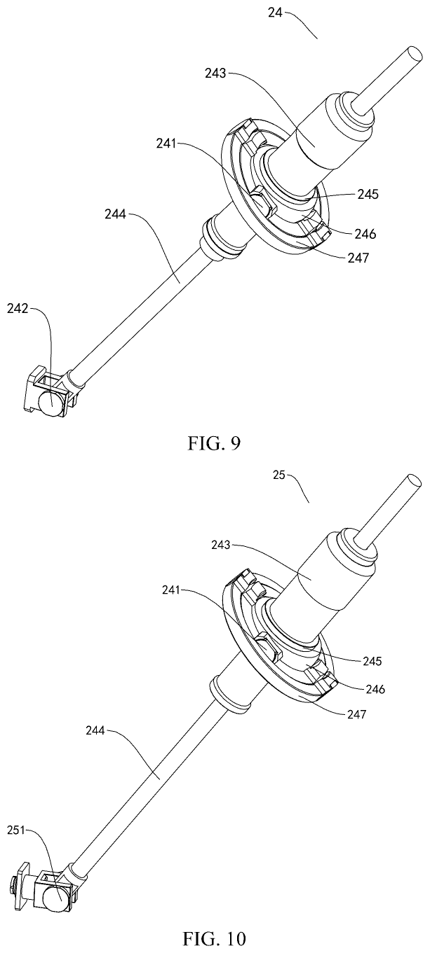

As illustrated in FIG. 1 to FIG. 15, the component processing system 100 according to the embodiments of the present disclosure may include: a positioning mechanism 10, a processing mechanism 20, and auxiliary tooling 30.

In an exemplary embodiment of the present disclosure, the positioning mechanism 10 includes a positioning base 11, a first transverse moving member 12, a longitudinal moving member 13, and a second transverse moving member 14. The first transverse moving member 12 is movably mounted at the positioning base 11 in a first transverse direction, the longitudinal moving member 13 is movably mounted at the first transverse moving member 12 in a longitudinal direction, and the second transverse moving member 14 is movably mounted at the longitudinal moving member 13 in a second transverse direction. Any two of the first transverse direction, the second transverse direction, and the longitudinal direction intersect with each other, such as being perpendicular to each other. For example, in the example illustrated in FIG. 1, the first transverse direction is the left-right direction, the second transverse direction is the front-rear direction, and the longitudinal direction is the up-down direction.

It is worth noting that, in the description of the present disclosure, the transverse direction includes, but is not limited to, the horizontal direction. For example, it may be a direction forming a certain angle (such as a 30° angle) with the transverse direction. Similarly, the longitudinal direction includes, but is not limited to, the vertical direction, and may also be a direction forming a certain angle with the vertical direction.

The first transverse moving member 12, the longitudinal moving member 13, and the second transverse moving member 14 move in three mutually intersecting directions, respectively, which can allow the second transverse moving member 14 of the positioning mechanism 10 to achieve large-range movement and preliminary positioning.

The processing mechanism 20 includes a processing base 21, a spindle assembly 22, and a pressing member 23. The processing base 21 is mounted at the second transverse moving member 14. The spindle assembly 22 is movably connected to the processing base 21 and configured to process a component 40, such as performing drilling, cutting, or other processing operations on the component 40. The pressing member 23 is movably connected to the processing base 21 and configured to contact and engage with the component 40. The spindle assembly 22 and the pressing member 23 are capable of moving independently.

For example, in some embodiments, the spindle assembly 22 includes a spindle 221 and a spindle motor 222. The spindle motor 222 drives the spindle 221 to rotate. The spindle 221 may be a cutting tool, a drill bit, etc., or it may be configured to mount the cutting tool, the drill bit, etc. The relative movement between the spindle assembly 22 and the processing base 21 includes at least one of rotation or movement. For example, the spindle 221 rotates relative to the processing base 21 under drive of the spindle motor 222, and the entire spindle assembly 22 moves axially to achieve axial feeding and the like.

In addition, the movement of the spindle assembly 22 and the movement of the pressing member 23 towards the component 40 are independent of each other, which allows the pressing member 23 to cooperate with the component 40 when the spindle assembly 22 is not performing a feeding movement, or to cooperate with the component 40 prior to the feeding movement of the spindle assembly 22. For example, the pressing member 23 can contact the component 40 when the spindle assembly 22 is not performing the feeding movement to facilitate detection of a distance between the pressing member 23 and the component 40. For another example, the pressing member 23 can press the component 40 prior to the feeding movement of the spindle assembly 22, in such a manner that during the feeding movement of the main assembly 40, the cooperation between the pressing member 23 and the component 40 reduces deformation of a surface of the component 40 caused by local low stiffness.

The auxiliary tooling 30 is located at a side of the positioning mechanism 10 in the second transverse direction and configured to fix the component 40. Different from large machine tools in the related art, the component 40 and the processing mechanism 20 are mounted at the auxiliary tooling 30 and the positioning mechanism 10, respectively, which helps to make a relative position between the component 40 and the processing mechanism 20 more flexible and variable, meeting processing requirements for components 40 of various dimensions, such as meeting the processing requirements of the large components 40. An overall dimension of the component processing system 100 is not easily limited by the dimension of the component 40, which is conducive to reducing the size and costs of the component processing system 100.

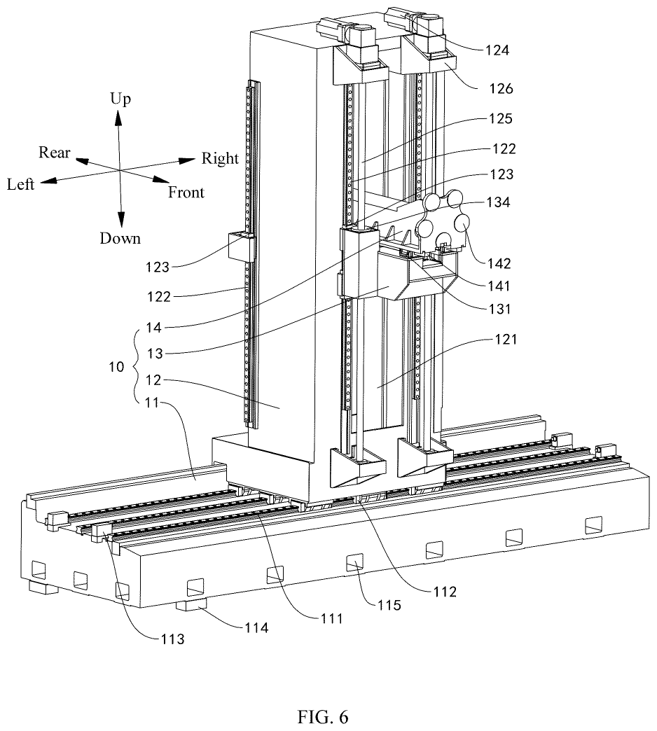

In some specific embodiments, as illustrated in FIG. 1 and FIG. 6, the first transverse moving member 12 of the positioning mechanism 10 is movably mounted at the positioning base 11 in the first transverse direction, the longitudinal moving member 13 is movably arranged in a mounting space of the first transverse moving member 12 in the longitudinal direction, and the second transverse moving member 14 is movably arranged above the longitudinal moving member 13 in the second transverse direction. In this way, the positioning mechanism 10 can achieve large-range movement in the first transverse direction, the longitudinal direction, and the second transverse direction. In addition, the second transverse moving member 14 of the positioning mechanism 10 is connected to the processing base 211 of the processing mechanism 20, which allows the processing mechanism 20 to achieve the large-range movement in the first transverse direction, the longitudinal direction, and the second transverse direction together with the positioning mechanism 10, facilitating preliminary positioning of a to-be-processed point of the component 40 by the processing mechanism 20.

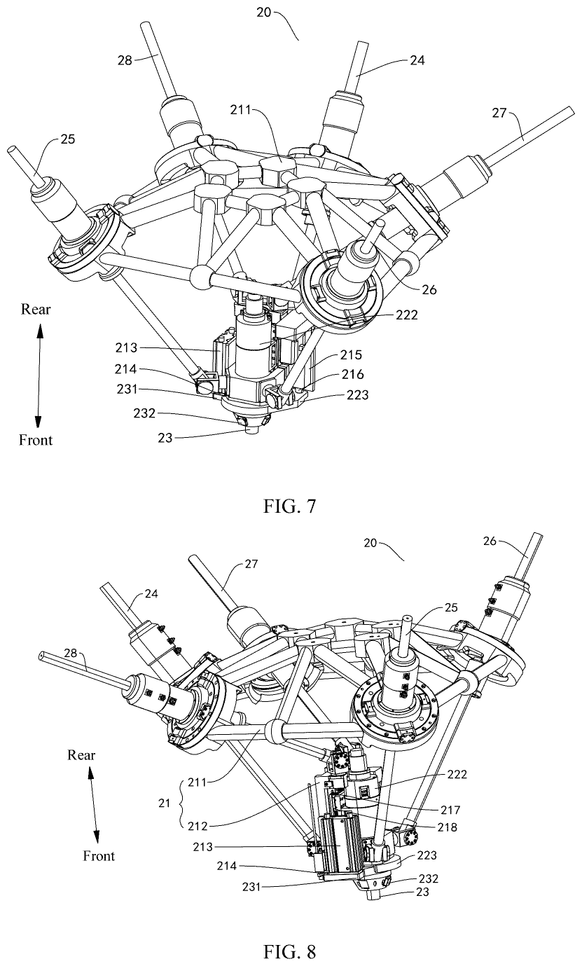

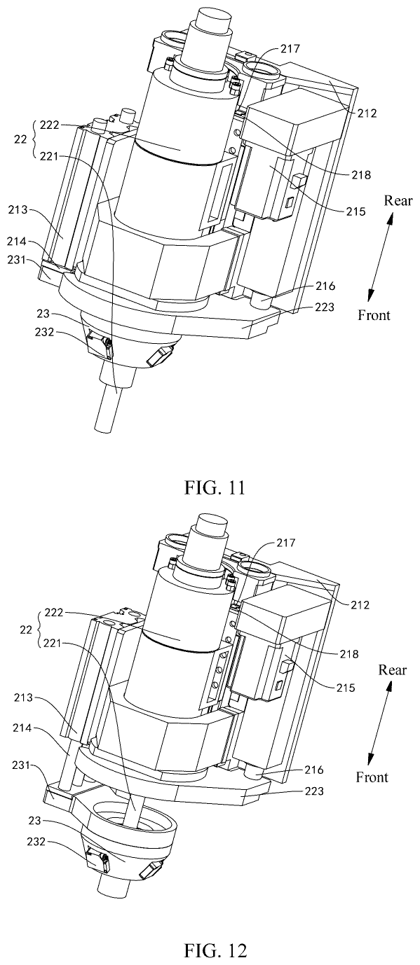

In addition, as illustrated in FIG. 1, FIG. 7 and FIG. 8, and FIG. 11 to FIG. 13, the pressing member 23 in the processing mechanism 20 is movably connected to the processing base 211, which can not only extend to contact the mechanism 20 to be processed but also retract to return to its initial state. The spindle assembly 22 is movably connected to the processing base 211, which can not only extend to perform drilling or other processing operations on the to-be-processed point of the component 40, but also retract to return to its initial state, awaiting the next processing operation or processing of the next to-be-processed point.

With the component processing system 100 according to the embodiments of the present disclosure, the processing mechanism 20 can achieve the large-range movement in the first transverse direction, the longitudinal direction, and the second transverse direction through cooperation of the first transverse moving member 12, the longitudinal moving member 13, and the second transverse moving member 14, to meet the processing requirements for the components 40 of various dimensions. In addition, independent movement of the pressing member 23 and the spindle assembly 22 can realize a wider range of operating modes, which is conducive to achieving high-quality local processing operations.

In some embodiments of the present disclosure, as illustrated in FIG. 7 and FIG. 8 and FIG. 11 to FIG. 13, the processing mechanism 20 further includes a first driving member 213 and a second driving member 215. The first driving member 213 is mounted at the processing base 21 and includes a first retractable portion 214. The pressing member 23 is provided with a first connection portion 231 at an outer circumferential surface of the pressing member 23. The first retractable portion 214 is connected to the first connection portion 231 and configured to drive the pressing member 23 to move axially. The second driving member 215 is mounted at the processing base 21 and includes a second retractable portion 216. The spindle assembly 22 is provided with a second connection portion 223 at an outer circumferential surface of the spindle assembly 22. The second retractable portion 216 is connected to the second connection portion 223 to drive the spindle assembly 22 to move axially.

In some specific embodiments of the present disclosure, as illustrated in FIG. 7 and FIG. 8, and FIG. 11 to FIG. 13, the first driving member 213 may be a cylinder, an electric push rod, or the like, and the second driving member 215 may be an electric push rod. The electric push rod has motion precision in an axial direction, which can meet the precision requirements for drilling. The first driving member 213 and the second driving member 215 may be the same or different.

When the first driving member 213 is in operation, the first retractable portion 214 extends outward and pushes the first connection portion 231 at the outer circumferential surface of the pressing member 23, allowing the pressing member 23 to move towards the component 40 to contact the surface of the component 40. For example, during the processing of the component 40, the component 40 can be pressed to limit its movement, to reduce the possibility of deformation of the surface of the component 40 due to local low stiffness; or functions such as position detection and distance detection can be achieved through contact with the component 40. In other embodiments of the present disclosure, when the first retractable portion 214 retracts, it can drive the pressing member 23 to move in a reserve direction to separate from the component 40, to facilitate re-extension for the next operation.

When the second driving member 215 is in operation, the second retractable portion 216 extends outward and pushes the second connection portion 223 at the outer circumferential surface of the spindle assembly 22, allowing the spindle assembly 22 to move axially, in such a manner that the spindle assembly 22 extends outward and the feeding operation is realized. For example, in some specific embodiments, as illustrated in FIG. 11 to FIG. 13, the spindle assembly 22 includes the spindle motor 222 and the spindle 221. The second driving member 215 drives the spindle motor 222 and the spindle 221 to move together towards the component 40 to realize the feeding operation. Also, the spindle motor 222 can drive the spindle 221 to rotate, and the cooperation of the two can realize processing operations such as drilling of the component 40. In other embodiments of the present disclosure, when the second driving member 215 retracts, it can drive the spindle assembly 22 to move in the reverse direction to separate from the component 40, to facilitate re-extension for the next processing.

In this way, the first driving member 213 provides driving force for the movement of the pressing member 23, and the second driving member 215 provides driving force for the movement of the spindle assembly 22, which ensures independent movement of the pressing member 23 and the spindle assembly 22, to allow them to perform processing operations on the component 40 separately and to perform processing operations on the component 40 cooperatively, helping to diversify the processing operations.

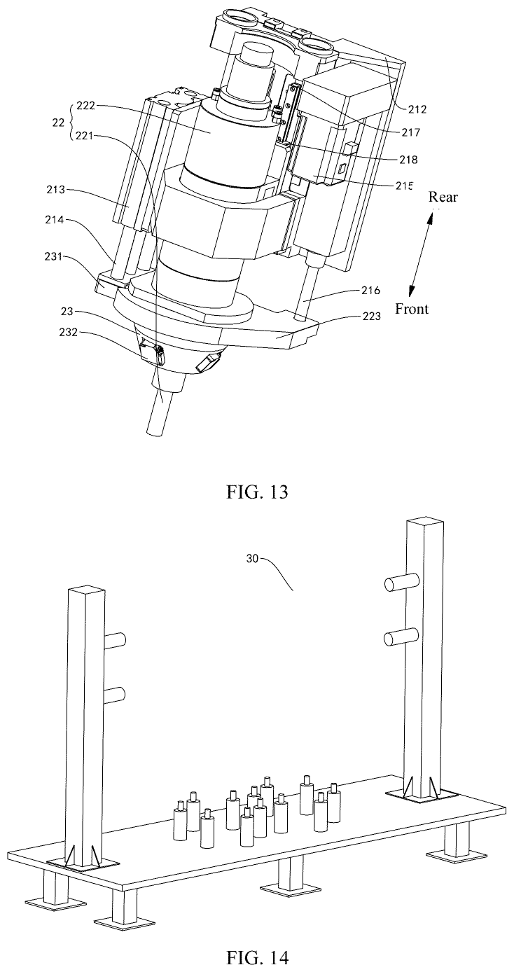

In some embodiments of the present disclosure, as illustrated in FIG. 11 to FIG. 13, the second connection portion 223 is disposed at an end portion of the first driving member 213 to close to the component 40 (e.g., a front end illustrated in FIG. 11), and the pressing member 23 is located at a side of the second connection portion 223 facing towards the component 40 (e.g., a front side illustrated in FIG. 11). A spindle 221 of the spindle assembly 22 passes through the pressing member 23. That is, when the first driving member 213 drives the pressing member 23 to extend, the spindle assembly 22 can remain stationary as illustrated in FIG. 12, or it can extend outward under the drive of the second driving member 215 as illustrated in FIG. 13. In other words, the movement of the pressing member 23 is not affected by the spindle assembly 22. Similarly, when the spindle 221 of the spindle assembly 22 moves, for example, when it rotates under the drive of the spindle motor 222, the pressing member 23 can remain stationary, or it can extend under the drive of the first driving member 213 as illustrated in FIG. 12. That is, the movements of the spindle 221 and the pressing member 23 are independent of each other, and the movement of the spindle 221 is not affected by the pressing member 23.

In some embodiments of the present disclosure, as illustrated in FIG. 7 to FIG. 10, the processing base 21 includes a first base 211, a second base 212, and five branch chains. The first base 211 is connected to the second transverse moving member 14, allowing the processing base 21 to move over a wide range in the second transverse direction along with the second transverse moving member 14 for preliminary positioning. Each of the five branch chains is connected to the first base 211 via a first hinge 241 with two intersecting rotational axes. One of the five branch chains (referred to herein as a first branch chain 24) is connected to the second base 212 via a second hinge 242. Each of the other four branch chains of the five branch chains (referred to herein as a second branch chain 25, a third branch chain 26, a fourth branch chain 27, and a fifth branch chain 28) is connected to the second base 212 via a third hinge 251 with two intersecting rotational axes. The branch chain includes a branch chain driving member 243 connected to the first hinge 241 and a branch chain lead screw 244 connected to the second hinge 242. The branch chain driving member 243 is threadedly engaged with the branch chain lead screw 244 and configured to drive the branch chain lead screw 244 to extend and retract axially.

In some embodiments of the present disclosure, the first branch chain 24 is connected to the first base 211 and the second base 212 via the first hinge 241 and the second hinge 242, respectively. The second branch chain 25, the third branch chain 26, the fourth branch chain 27, and the fifth branch chain 28 have the same structure and are each connected to the first base 211 and the second base 212 via the second hinge 242 and the third hinge 251, respectively. The five branch chains are engaged with the first base 211 and the second base 212 to form a closed-loop structure. By using the branch chain driving member 243 to drive the first branch chain 24, the second branch chain 25, the third branch chain 26, the fourth branch chain 27, and the fifth branch chain 28 to perform coordinated retractable movements, the second base 212 can achieve five degrees of freedom of motion, specifically three translational degrees of freedom of motion in the first transverse direction, the longitudinal direction, and the second transverse direction and two rotational degrees of freedom of motion about the first transverse direction and the second transverse direction.

In addition, the spindle assembly 22, the first driving member 213, and the second driving member 215 are all arranged at the second base 212. In this way, the second base 212 achieves five degrees of freedom of motion, which in turn drives the spindle assembly 22 to achieve five degrees of freedom of motion. Therefore, precise positioning and adjustment of the spindle assembly 22 are achieved, to meet the complex processing requirements of the large component 40, such as its large dimension, variable angles of its free-form surface, and its layered characteristics, effectively improving operational complexity and processing accuracy.

In some embodiments of the present disclosure, as illustrated in FIG. 7 and FIG. 8, in an axial direction of the spindle assembly 22, five first hinges 241 are located at a same level, the second hinge 242 and two third hinges 251 are located at a same level and connected to a lower part of the second base 212, and the other two third hinges 251 are located at a same level and connected to an upper part of the second base 212. “Higher level” refers to a larger distance between the hinge and the component 40 in the axial direction of the spindle assembly 22, and “lower level” refers to a smaller distance between the hinge and the component 40 in the axial direction of the spindle assembly 22. A difference in the levels among various revolute pairs allows each of the five branch chains to perform retractable movements in different directions within the three-dimensional space, and is more conducive to control of the position and orientation of the spindle assembly 22 by each of the five branch chains.

In some embodiments of the present disclosure, as illustrated in FIG. 7 and FIG. 8, in a circumferential direction of the spindle assembly 22, the second hinge 242 and two third hinges 251 (e.g., the third hinges 251 corresponding to the second branch chain 25 and the fifth branch chain 28 illustrated in FIG. 8) are located at a lower level are evenly arranged at intervals, and the other two third hinges 251 (e.g., the third hinges 251 corresponding to the third branch chain 26 and the fourth branch chain 27 illustrated in FIG. 8) are located at a lower level are evenly arranged at intervals, and each of the other two third hinges 251 is located between the second hinge 242 located at a higher level and the third hinge 251. This arrangement reduces the number of branch chains required for orientation adjustment of the spindle assembly 22, and makes the force exerted by each branch chain on the second base 212 more uniform and orderly, which facilitates precise control of the five degrees of freedom, enabling precise control of the position and orientation of the spindle assembly 22. In addition, the mounting of the branch chains is also more convenient.

In some embodiments of the present disclosure, the first branch chain 24 includes: a branch chain lead screw 244, a branch chain driving member 243, a first hinge 241, and a second hinge 242. The branch chain lead screw 244 is threadedly connected to the branch chain driving member 243, and the branch chain driving member 243 may be a hollow motor that drives the branch chain lead screw 244 to extend and retract. The first hinge 241 is a U-joint, i.e., a universal joint, which consists of two revolute pairs with mutually perpendicular axes. The first hinge 241 includes an inner ring 245, an intermediate ring 246, and a fixed ring 247. The fixed ring 247 is connected to the first base 211, and the intermediate ring 246 and the fixed ring 247 can rotate relative to each other about a tangential direction of the spindle assembly 22. The inner ring 245 is connected to the branch chain driving member 243, and the inner ring 245 and the intermediate ring 246 can rotate relative to each other about a radial direction of the spindle assembly 22. The second hinge 242 is connected to the second base 212 through a revolute pair whose rotation axis is parallel to a tangent of the spindle assembly 22. The first hinges 241 of the second branch chain, third branch chain, fourth branch chain, and fifth branch chain have the same structure as the first hinge 241 of the first branch chain. The third hinge 251 has an additional degree of freedom for radial rotation about the spindle assembly 22 compared with the second hinge 242. The above-described branch chains have advantages of lightweight, high rigidity, and high flexibility.

In some embodiments of the present disclosure, as illustrated in FIG. 1 and FIG. 2, and FIG. 6, the positioning base 11 is provided with a first slide rail 111 extending in the first transverse direction. The first slide rail 111 is provided with two stop portions 113 at two ends of the first slide rail 111 in the first transverse direction, respectively. The first transverse moving member 12 is provided with a first slide block 112 at a bottom of the first transverse moving member 12, and the first slide block 112 is slidable along the first slide rail 111 between the two stop portions 113. The first transverse moving member 12 can achieve the large-range movement in the first transverse direction for the preliminary positioning of the processing mechanism 20 through sliding of the first slide block 112 at the bottom of the first transverse moving member 12 along the first slide rail 111 at the positioning base 11 in first transverse direction. In addition, the stop portions 113 at the two ends of the first slide rail 111 can limit the movement of the first transverse moving member 12 to prevent the first transverse moving member 12 from falling off.

In some specific embodiments, as illustrated in FIG. 1 and FIG. 2, and FIG. 6, the positioning base 11 is further provided with shims 114 and lightening holes 115. As illustrated in FIG. 2, the shims 114 are arranged around the bottom of the positioning base 11, which can reduce vibration generated by the component processing system 100 during processing. The lightening holes 115 are arranged around a circumferential surface of the positioning base 11, which can reduce weight of the positioning base 11, lower costs.

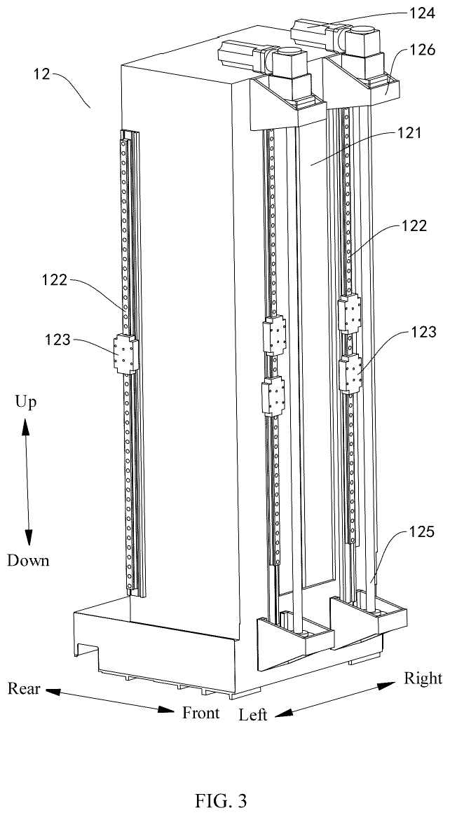

In some embodiments of the present disclosure, as illustrated in FIG. 1, FIG. 3, and FIG. 6, the first transverse moving member 12 has a mounting space 121 extending in the longitudinal direction, and the mounting space 121 extends through the first transverse moving member 12 in the second transverse direction. The first transverse moving member 12 is provided with a second slide rail 122 on at least one side of the first transverse moving member 12 in the second transverse direction, and the second slide rail 122 extends in the longitudinal direction. The longitudinal moving member 13 passes through the mounting space 121 and is slidably engaged with the second slide rail 122 via a second slide block 123. The first transverse moving member 12 is provided with a first motor 124 and a first lead screw 125. The first lead screw 125 extends in the longitudinal direction and is threadedly engaged with the longitudinal moving member 13. The first motor 124 is connected to the first lead screw 125 and configured to drive the first lead screw 125 to rotate. The first lead screw 125 rotates to drive the longitudinal moving member 13 to move in the longitudinal direction, to achieve the large-range movement of the positioning mechanism 10 in the longitudinal direction for the preliminary positioning of the processing mechanism 20.

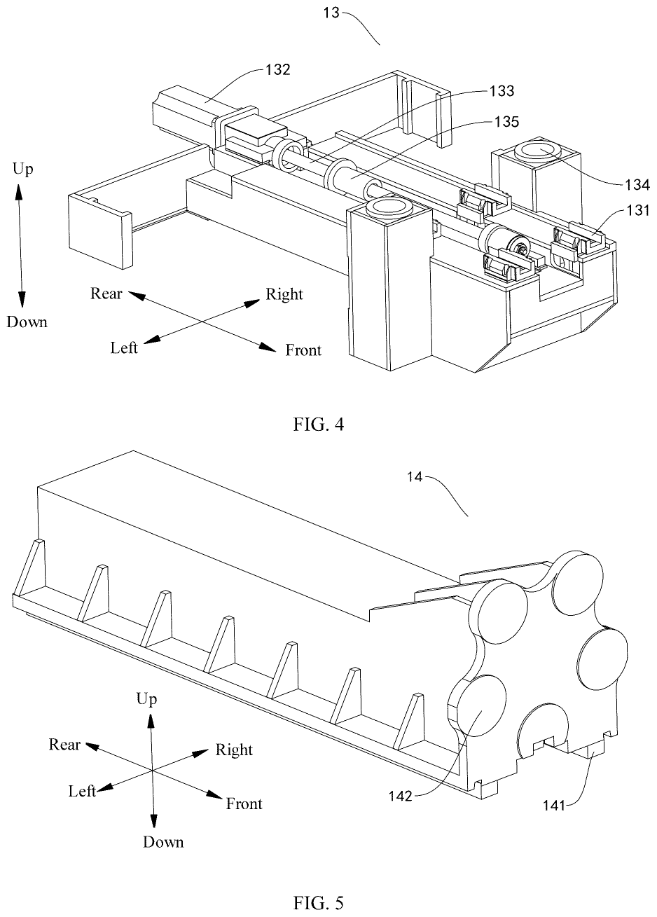

In some specific embodiments, as illustrated in FIG. 4 and FIG. 6, the first transverse moving member 12 is provided with two second slide rails 122 at two sides of the first transverse moving member 12 in the second transverse direction, respectively, and the longitudinal moving member 13 is provided with two second slide blocks 123 at two sides of the longitudinal moving member 13 in the second transverse direction, respectively, in such a manner that the longitudinal moving member 13 is movably arranged in the mounting space 121 of the first transverse moving member 12. The longitudinal moving member 13 is provided with first nuts 134 at two sides of the longitudinal moving member 13 in the first transverse direction, and the first nut 134 is threadedly engaged with the first lead screw 125 at the first transverse moving member 12. When the first motor 124 drives the first lead screw 125 to rotate, the first nut 134 drives the longitudinal moving member 13 to move in an axial direction of the first lead screw 125. In addition, the longitudinal moving member 13 is guided by cooperation of the second slide blocks 123 and the second slide rails 122, which can allow the longitudinal moving member 13 to move stably in the longitudinal direction within the mounting space 121.

In some embodiments of the present disclosure, as illustrated in FIG. 1, and FIG. 4 to FIG. 6, the longitudinal moving member 13 and the second transverse moving member 14 are slidably engaged with the third slide rail 141 via a third slide block 131, and the third slide rail 141 extends in the second transverse direction. One of the third slide block 131 and the third slide rail 141 is arranged in the longitudinal moving member 13, and another of the third slide block 131 and the third slide rail 141 is arranged in the second transverse moving member 14. The longitudinal moving member 13 is provided with a second motor 132 and a second lead screw 133. The second lead screw 133 extends in the second transverse direction and is threadedly engaged with the second transverse moving member 14 via a second nut 135. The second motor 132 is connected to the second lead screw 133 and configured to drive the second lead screw 133 to rotate, and the second lead screw 133 rotates to drive the second transverse moving member 14 to move in the second transverse direction.

For example, as illustrated in FIG. 4 to FIG. 6, a fixed third slide block 131 is arranged at the longitudinal moving member 13, and the third slide rail 141 is arranged at the second transverse moving member 14. The third slide block 131 has a groove extending in the second transverse direction, and the third slide rail 141 is an elongated protrusion extending in the second direction. The elongated protrusion is embedded in the groove and slidable along the groove, in such a manner that the second transverse moving member 14 is movably arranged at the longitudinal moving member 13. In addition, the second nut 135 is arranged at the longitudinal moving member 13. The second nut 135 is threadedly connected to the second lead screw 133 at the longitudinal moving member 13 and fixedly connected to the second transverse moving member 14. When the second motor 132 at the longitudinal moving member 13 drives the second lead screw 133 to rotate, the second nut 135 at the second lead screw 133 can move in an axial direction of the second lead screw 133. In this case, the second transverse moving member 14 is guided by cooperation of the third slide rail 141 and the third slide block 131, which can allow the second transverse moving member 14 to move stably in the second transverse direction at the longitudinal moving member 13.

In some embodiments of the present disclosure, as illustrated in FIG. 1 and FIG. 14, the auxiliary tooling 30 and the positioning mechanism 10 are arranged independently. The auxiliary tooling 30 is configured to fix the component 40 to be processed. The independent arrangement makes the mounting of the component 40 more convenient, avoiding a situation where the component 40 is unable to be mounted due to limited mounting space. Therefore, restriction of traditional machine tools on the operating space is eliminated, which can meet fixing and processing requirements of the large components 40.

In some embodiments of the present disclosure, as illustrated in FIG. 1, FIG. 7 and FIG. 8, and FIG. 11 to FIG. 13, the pressing member 23 is provided with a plurality of distance detection members 232 that are arranged at intervals in a circumferential direction of the pressing member 23 and configured to detect a distance between the pressing member 23 and the component 40. The spindle assembly 22 is adapted to adjust an axial angle according to detection results of the plurality of distance detection members 232. For example, the distance detection member 232 may be a laser rangefinder, etc.

In an exemplary embodiment of the present disclosure, the plurality of distance detection members 232 operates together to detect the distance between the plurality of distance detection members 232 and the component 40 in three-dimensional space, to facilitate determination of an actual normal direction of the to-be-processed point based on the detection results. Through control of the spindle assembly 22 to make precise adjustments in five degrees of freedom by the five branch chains, the axial direction of the spindle 221 aligns with the actual normal direction of the to-be-processed point.

In this way, the component processing system 100 can meet the processing requirements for the component 40 with complex structural features such as the free-form surface, facilitating to achieving the high-quality local processing. For example, coaxiality between a drilling axis and a normal line of the to-be-processed point is improved during drilling.

In addition, in the embodiments where the pressing member 23 and the spindle assembly 22 are capable of moving independently, the pressing member 23 can move independently to drive the distance detection members 232 to move towards the component 40. When the pressing member 23 comes into contact with the surface of the component 40, the distance detection members 232 perform distance detection, which can improve detection accuracy. Also, the detection process is not affected by the spindle assembly 22.

In some embodiments of the present disclosure, as illustrated in FIG. 7 and FIG. 8, and FIG. 11 to FIG. 13, three or more distance detection members 232 are provided. The pressing member 23 includes a conical surface at a surface of the pressing member 23 facing towards the component 40, and the three or more distance detection members 232 are disposed at the conical surface. The conical surface can prevent a structure of the pressing member 23 from interfering with the three or more distance detection process, which is beneficial to improving the accuracy of distance detection and enhancing the coaxiality between arrangement positions of a plurality of distance detection members 232 and the axis of the spindle assembly 22.

In some specific embodiments, the component processing system 100 uses four distance detection members 232 for detection. Three of the four distance detection members 232 can detect the position in the three-dimensional space and calculate the normal direction of the to-be-processed point accordingly, while the fourth distance detection member 232 can verify and calibrate the calculation results. Overall, distance detection time of the component processing system 100 can be shortened and the accuracy of normal line detection of the to-be-processed point can be improved, enhancing an operating efficiency.

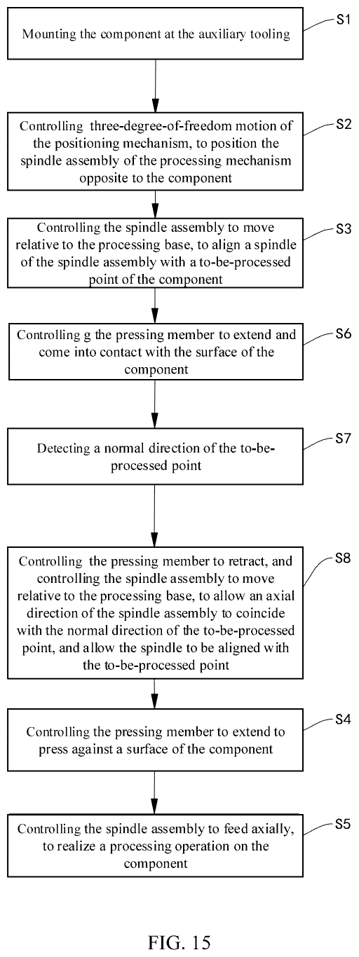

A control method of the component processing system 100 according to the embodiments of the present disclosure, as illustrated in FIG. 15, includes the following operations.

At S1, the component 40 is mounted at the auxiliary tooling 30.

At S2, the three-degree-of-freedom motion of the positioning mechanism 10 is controlled, to position the spindle assembly 22 of the processing mechanism 20 opposite to the component 40.

For example, as illustrated in FIG. 1 and FIG. 6, the three degrees of freedom of the positioning mechanism 10 are provided by the first transverse moving member 12, the longitudinal moving member 13, and the second transverse moving member 14, respectively. In some embodiments of the present disclosure, as illustrated in FIG. 1, in the positioning mechanism 10, the first transverse moving member 12 is movable in the first transverse direction at the positioning base 11 under guidance of the first slide block 112 and the first slide rail 111, the longitudinal moving member 13 is driven by the first motor 124 to move in the longitudinal direction under guidance of the second slide block 123 and the second slide rail 122, and the second transverse moving member 14 is driven by the second motor 132 to move in the second transverse direction under guidance of the third slide block 131 and the third slide rail 141. Therefore, the three-degree-of-freedom motion is achieved, and the spindle assembly 22 of the processing mechanism 20 is positioned opposite to the component 40, that is, the spindle assembly 22 is moved to the vicinity of the to-be-processed point of the component 40, achieving the preliminary positioning.

At S3, the spindle assembly 22 is controlled to move relative to the processing base 21, to align a spindle 221 of the spindle assembly 22 with a to-be-processed point of the component 40.

In some embodiments of the present disclosure, as illustrated in FIG. 7 and FIG. 8, the five branch chains rotatably connect the first base 211 and the second base 212. The branch chain driving member 243 drives the branch chain lead screw 244 to rotate, achieving axial extension and retraction of the branch chains. Therefore, five-degree-of-freedom motion adjustment of the spindle assembly 22 is achieved, aligning the axial direction of the spindle 221 of the spindle assembly 22 with the actual normal direction of the to-be-processed point at the component 40. In addition, the end portion of the spindle 221 is positioned opposite to the to-be-processed point, facilitating the spindle 221 to accurately acting on the to-be-processed point during feeding.

At S4, the pressing member 23 is controlled to extend to press against a surface of the component 40.

In some embodiments of the present disclosure, as illustrated in FIG. 12, the first driving member 213 of the processing mechanism 20 drives the first retractable portion 214 to extend. The first retractable portion 214 is connected to the first connection portion 231, pushing the first connection portion 231 to move outward. The first connection portion 231 is connected to the pressing member 23, driving the pressing member 23 to extend. In this way, the pressing member 23 presses against the surface of the component 40 to limit and support the component 40, preventing the component 40 from moving or deforming during processing.

At S5, the spindle assembly 22 is controlled to feed axially, to realize a processing operation on the component 40.

In some embodiments of the present disclosure, as illustrated in FIG. 13, the second driving member 215 of the processing mechanism 20 drives the second retractable portion 216 to extend. The second retractable portion 216 is connected to the second connection portion 223, pushing the second connection portion 223 to move outward. The second connection portion 223 is connected to the spindle assembly 22, allowing the spindle assembly 22 to feed axially. In addition, the spindle motor 222 drives the spindle 221 to rotate, realizing the processing operation of the spindle 221 on the component 40.

With the control method for the component processing system 100 according to the embodiments of the present disclosure, the processing mechanism 20 can achieve the large-range movement in the first transverse direction, the longitudinal direction, and the second transverse direction, to meet the processing requirements for the components 40 of various dimensions. In addition, independent movement of the pressing member 23 and the spindle assembly 22 can realize a wider range of operating modes, which is conducive to achieving high-quality local processing operations.

According to some embodiments of the present disclosure, as illustrated in FIG. 15, prior to the operation at block S4, the control method for the component processing system 100 further includes the following operations.

At S6, the pressing member 23 is controlled to extend and come into contact with the surface of the component 40.

In some embodiments of the present disclosure, as illustrated in FIG. 12, the first driving member 213 drives the pressing member 23 to extend through the first retractable portion 214 and the first connection portion 231, enabling the pressing member 23 to come into contact with the surface of the component 40.

At S7, a normal direction of the to-be-processed point is detected.

In some embodiments of the present disclosure, as illustrated in FIG. 12, three or more distance detection members 232 are arranged at the conical surface at the surface of the pressing member 23 facing towards the surface of the component 40. In an exemplary embodiment of the present disclosure, the number of distance detection members 232 may be four. After the first driving member 213 controls the pressing member 23 to extend and come into contact with the surface of the component 40, the distance detection members 232 at the pressing member 23 begin to detect the distance to the to-be-processed point at the surface of the component 40. Three of the four distance detection members 232 determine the normal direction of the to-be-processed point, and a remaining one of the four distance detection members 232 verifies and calibrates the detected normal direction, to improve the accuracy of normal direction detection.

At S8, the pressing member 23 is controlled to retract and the spindle assembly 22 is controlled to move relative to the processing base 21, to allow an axial direction of spindle assembly 22 to coincide with the normal direction of the to-be-processed point, and allow the spindle 221 to be aligned with the to-be-processed point.

In some embodiments of the present disclosure, as illustrated in FIG. 11 and FIG. 12, subsequent to detecting the normal direction of the to-be-processed point, the first driving member 213 controls pressing member 23 to retract, and the five branch chains control the spindle assembly 22 to move relative to the processing base 21 to achieve precise adjustment of five degrees of freedom, in such a manner that the axial direction of the spindle 221 of spindle assembly 22 coincides with the actual normal direction of the to-be-processed point at the component 40, and the spindle 221 is aligned with the to-be-processed point, avoiding incorrect positioning of the to-be-processed point when the spindle assembly 22 feeds axially to process the component 40.

The component processing system 100 and the control method therefor according to a specific embodiment of the present disclosure are described in detail below with reference to the accompanying drawings. It is worth understanding that the following description is merely illustrative and should not be construed as limiting the present disclosure.

As illustrated in FIG. 1 to FIG. 14, the component processing system 100 according to a specific embodiment of the present disclosure includes the positioning mechanism 10, the processing mechanism 20, and the auxiliary tooling 30.

The positioning mechanism 10 includes the positioning base 11, the first transverse moving member 12, the longitudinal moving member 13, and the second transverse moving member 14. The positioning base 11 supports the first transverse moving member 12, the longitudinal moving member 13, the second transverse moving member 14, and the processing mechanism 20. As illustrated in FIG. 1 and FIG. 2, and FIG. 6, a plurality of shims 114 are evenly arranged at the bottom of the positioning base 11, which can reduce the vibration generated by the component processing system 100 during processing operations, making the component processing system 100 more stable. Also, a plurality of lightening holes 115 are evenly arranged around the positioning base 11, which can reduce the weight of the positioning base 11, improving operational stability. In addition, the first slide rail 111, the first slide block 112, and the stop portions 113 are arranged above the positioning base 11. The first slide rail 111 is slidably connected to the first slide block 112, and the first slide block 112 is fixedly connected to the first transverse moving member 12, which allows the first transverse moving member 12 to slide in the first transverse direction at the first slide rail 111. In this way, the positioning mechanism 10 is endowed with a degree of freedom in the first transverse direction, achieving the large-range movement and preliminary positioning of the positioning mechanism 10 in the first transverse direction. Furthermore, the stop portions 113 are arranged at the two ends of the first slide rail 111, which can control the movable range of the first transverse moving member 12, effectively preventing the first transverse moving member 12 from sliding off the positioning base 11.

The first transverse moving member 12 is movably arranged at the positioning base 11 via the first slide block 112. As illustrated in FIG. 1, FIG. 3 and FIG. 4, and FIG. 6, the first transverse moving member 12 includes the mounting space 121, the second slide rail 122, the first motor 124, the first lead screw 125, and a motor bracket 126. The mounting space 121 is arranged longitudinally in the first transverse moving member 12 and extends through the first transverse moving member 12 in the second transverse direction, to accommodate the longitudinal moving member 13 and the second transverse moving member 14.

The first motor 124 and the motor bracket 126 are arranged at a longitudinal upper end of the first transverse moving member 12. The motor bracket 126 supports the first motor 124, which can reduce operational vibration of the first motor 124 and enhance its operational stability. An upper end of the first lead screw 125, arranged longitudinally at the longitudinal moving member 13, is connected to the first motor 124 and rotates under the drive of the first motor 124. The first lead screw 125 is threadedly connected to the first nut 134 located at the longitudinal moving member 13, allowing the first nut 134 to move in the longitudinal direction.

In addition, the second slide rails 122 are arranged at the two sides of the first transverse moving member 12 in the second transverse direction, respectively. The second slide rails 122 are each slidably connected to the second slide block 123, and the second slide block 123 is fixedly connected to the longitudinal moving member 13, allowing the longitudinal moving member 13 to slide longitudinally at the second slide rails 122. To enhance stability of longitudinal sliding, two second slide rails 122, which are spaced apart from each other in the first transverse direction, are disposed at the first transverse moving member 12. Therefore, the first motor 124 drives the first lead screw 125 to rotate, which can enable the longitudinal moving member 13 to slide longitudinally at the first lead screw 125 along with the first nut 134. Also, the second slide blocks 123 and the second slide rails 122 guide the longitudinal sliding of the longitudinal moving member 13, endowing the positioning mechanism 10 with a degree of freedom in the longitudinal direction, and realizing the large-range movement and preliminary positioning of the positioning mechanism 10 in the longitudinal direction.

As illustrated in FIG. 1, and FIG. 4 to FIG. 6, the longitudinal moving member 13 includes the third slide block 131, the second motor 132, the second lead screw 133, the first nut 134, and the second nut 135. The first nut 134 is threadedly connected to the first lead screw 125 arranged at the first transverse moving member 12, which can enable the longitudinal moving member 13 to move in the longitudinal direction at the first transverse moving member 12. The second motor 132 drives the second lead screw 133 arranged at the longitudinal moving member 13 in the second transverse direction to rotate. The second lead screw 133 is threadedly connected to the second nut 135, and the second nut 135 is fixedly connected to the second transverse moving member 14, allowing the second transverse moving member 14 to move in the second transverse direction along with the second nut 135.

In addition, the third slide block 131 is fixed at the longitudinal moving member 13 and movably connected to the third slide rail 141 arranged at the second transverse moving member 14, enabling the second transverse moving member 14 to move in the second transverse direction at the longitudinal moving member 13. Therefore, the second motor 132 drives the second lead screw 133 to rotate, which can allow the second transverse moving member 14 to slide in the second transverse direction at the second lead screw 133 along with the second nut 135. Also, the third slide rail 141 and the third slide block 131 cooperate to guide the second transverse sliding, which endows the positioning mechanism 10 with a degree of freedom in the second transverse direction, achieving the large-range movement and preliminary positioning of the positioning mechanism 10 in the second transverse direction.

As illustrated in FIG. 1, FIG. 4 to FIG. 6, and FIG. 7 and FIG. 8, the second transverse moving member 14 includes the third slide rail 141 and a base connection portion 142. The third slide rail 141 is movably connected to the third slide block 131 arranged at the longitudinal moving member 13, which can enable the second transverse moving member 14 to move in the second transverse direction at the longitudinal moving member 13. The base connection portion 142 is located at a front end of the second transverse moving member 14 and configured to connect the second transverse moving member 14 to the first base 211. By connecting the processing mechanism 20 to the positioning mechanism 10 through the first base 211, the processing mechanism 20 achieves the large-range movement and preliminary positioning in the first transverse direction, the longitudinal direction, and the second transverse direction.

The processing mechanism 20 includes the processing base 21, the spindle assembly 22, and the pressing member 23. The processing base 21 includes the first base 211, the second base 212, and the five branch chains. As illustrated in FIG. 1, and FIG. 7 to FIG. 10, the first base 211 is connected to the base connection portion 142 of the second transverse moving member 14, which achieves connection between the processing mechanism 20 and the positioning mechanism 10. Therefore, the processing mechanism 20 can realize the large-range movement and preliminary positioning in the first transverse direction, the longitudinal direction, and the second transverse direction along with the positioning mechanism 10.

In addition, the first base 211 is also connected to the first hinge 241 of each of the five branch chains. The five first hinges 241 are evenly arranged at intervals and located t the same level in the circumferential direction of the spindle assembly 22. The second base 212 is connected to each of the second hinge 242 of the first branch chain 24 and the third hinges 251 of the remaining four branch chains. In the circumferential direction of the spindle assembly 22, the second hinge 242 and two third hinges 251 are evenly arranged at intervals and located at the same level at the lower part of the second base 212. The other two third hinges 251 are arranged between the second revolute hinge 242 and the two third hinges 251 located at the lower part of the second base 212, and located at the same level at the upper part of the second base 212. Each of the five branch chains includes the branch chain driving member 243 and the branch chain lead screw 244. The branch chain driving member 243 is threadedly connected to and engaged with the branch chain lead screw 244, which can drive the branch chain lead screw 244 to extend and retract in the axial direction, achieving five-degree-of-freedom position and orientation adjustment and aligning the axial direction of the spindle 221 with the actual normal direction of the to-be-processed point.

In addition, the processing base 21 further includes the first driving member 213, the second driving member 215, the fourth slide rail 217, and the fourth slide block 218. The first driving member 213 drives the first retractable portion 214 to extend or retract. The first retractable portion 214 is connected to the first connection portion 231 arranged at the pressing member 23, to drive the pressing member 23 to extend or retract through the first connection portion 231, in such a manner that the pressing member 23 can contact, press against, or separate from the component 40. The second driving member 215 drives the second retractable portion 216 to extend or retract. The second retractable portion 216 is connected to the second connection portion 223 arranged at the spindle assembly 22, to drive the spindle assembly 22 to extend or retract through the second connection portion 223, in such a manner that the spindle assembly 22 can perform the processing operations on the to-be-processed point. In an exemplary embodiment of the present disclosure, the first driving member 213 is a cylinder, and the second driving member 215 is an electric push rod. The fourth slide block 218 is fixedly connected to the spindle assembly 22, which allows the spindle assembly 22 to move along the fourth slide rail 217 via the fourth slide block 218, guiding the retractable movement of the spindle assembly 22.

As illustrated in FIG. 1, FIG. 7 and FIG. 8, and FIG. 11 to FIG. 13, the spindle assembly 22 includes the spindle 221, the spindle motor 222, and the second connection portion 223. The movement of the spindle 221 includes rotation and translation. In an exemplary embodiment of the present disclosure, the spindle 221 is located in the middle of the hollow spindle motor 222 and passes through the pressing member 23. A shaft end of the spindle 221 adjacent to the component 40 is configured for the processing operations. Therefore, the spindle 221 may be a cutting tool, a drill bit, etc., or a cutting tool, a drill bit, etc., may be mounted at the end portion adjacent to the component 40, to perform the processing operations on the to-be-processed point of the component 40. The spindle motor 222 drives the spindle 221 to rotate, while the second connection portion 223, driven by the second driving member 215, allows the entire spindle assembly 22 to feed. The rotation of the spindle 221 driven by the spindle motor 222, in coordination with the feeding movement, achieves the processing operations such as drilling on the to-be-processed point by the spindle 221.

As illustrated in FIG. 1, FIG. 7 and FIG. 8, and FIG. 11 to FIG. 13, the pressing member 23 includes the first connection portion 231 and the distance detection members 232. Driven by the first driving member 213, the first connection portion 231 drives the pressing member 23 to extend or retract, achieving contact or compression between the pressing member 23 and the surface of the component 40, reducing the possibility of deformation of the component 40 due to local low stiffness during the drilling. Four distance detection members 232 are evenly arranged at intervals at the conical surface portion of the pressing member 23 facing towards the component 40 and configured to detect the distance to the to-be-processed point at the surface of the component 40. Three of the four distance detection members 232 detect the normal direction of the to-be-processed point, and the fourth distance detection member 232 is configured for verification and calibration, which is beneficial to improving the accuracy of normal line detection, achieving high-quality drilling, and enhancing the processing efficiency of the component processing system 100. It is worth noting that the spindle assembly 22 and pressing member 23 are capable of moving independently. That is, the feeding of the spindle 221, the extension of the pressing member 23, and the distance measurement of the rod 244 do not affect each other, ensuring the positioning accuracy of the processing mechanism 20.

The auxiliary tooling 30 is arranged at the side of the positioning mechanism 10 in the second transverse direction, as illustrated in FIG. 1 and FIG. 14. The auxiliary tooling 30 is configured to fix the component 40, and the auxiliary tooling 30 and the positioning mechanism 10 are arranged independently, which can eliminate the restriction of traditional machine tools on the operating space, making the mounting and processing of the component 40 more convenient.

As illustrated in FIG. 15 to FIG. 17, the control method for the component processing system 100 includes the following operations.

At S1, the component 40 to be processed is mounted at the independently arranged auxiliary tooling 30.

At S2, the positioning mechanism 10 is controlled to move in the first transverse direction, the longitudinal direction, and the second transverse direction, to position the spindle assembly 22 that is connected to the positioning mechanism 10 opposite to the component 40 to be processed.

At S3, the spindle assembly 22 is controlled to move relative to the first base 211 through the five branch chains, to align the spindle 221 of the spindle assembly 22 with the to-be-processed point of the component 40.

At S4, the pressing member 23 is controlled by the first driving member 213 to extend and come into contact with the surface of the component 40.

At S5, the normal direction of the to-be-processed point is detected by the distance detection members 232.

At S6, the pressing member 23 is controlled by the first driving member 213 to retract, and the spindle assembly 22 is controlled by the five branch chains to move relative to the first base 211, such that the axial direction of the spindle assembly 22 coincides with the normal direction of the to-be-processed point, and the spindle 221 is aligned with the to-be-processed point.

At S7, the pressing member 23 is controlled by the first driving member 213 to extend to press against the surface of the component 40, reducing the possibility of deformation due to the low stiffness of the surface of the component 40.

At S8, the spindle assembly 22 is controlled by the second driving member 215 to feed axially, and the spindle 221 is driven by the spindle motor 222 to rotate, realizing the drilling operation on the component 40.

In the above-described operations, through the component processing system 100, a high-quality local drilling operation on the large component 40 can be achieved. Repeating the above-described operations can complete the next processing operation, to complete the overall drilling operation of the large component 40.

In this way, the component processing system 100 can process components 40 featuring large dimensions, low rigidity, and free-form surfaces, achieving significant improvements in the processing range, operational complexity, processing efficiency, and processing accuracy. Therefore, the component processing system 100 is endowed with the large-range movement and local precision processing, which eliminates the restriction of traditional machine tools on the operating space.

Other configurations and operations of the component processing system 100 according to the embodiments of the present disclosure are known to those skilled in the art and will not be described in detail herein.

In the description of the present disclosure, it should be noted that, unless otherwise clearly specified and limited, terms such as “install”, “connect”, “connect to”, and the like should be understood in a broad sense. For example, it may be a fixed connection or a detachable connection or connection as one piece; mechanical connection or electrical connection; direct connection or indirect connection through an intermediate; internal communication of two components. For those of ordinary skill in the art, the specific meaning of the above-mentioned terms in the present disclosure can be understood according to specific circumstances.

Reference throughout this specification to “an embodiment”, “a specific embodiment”, or “an example” means that a particular feature, structure, material, or characteristic described in connection with the embodiment or example is included in at least one embodiment or example of the present disclosure. In this specification, exemplary descriptions of aforesaid terms are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

1. A control method for a component processing system, wherein the component processing system comprises:
a positioning mechanism, wherein the positioning mechanism comprises a positioning base, a first transverse moving member, a longitudinal moving member, and a second transverse moving member, wherein the first transverse moving member is movably mounted at the base in a first transverse direction, wherein the longitudinal moving member is movably mounted at the first transverse moving member in a longitudinal direction, and wherein the second transverse moving member is movably mounted at the longitudinal moving member in a second transverse direction, any two of the first transverse direction, the second transverse direction, and the longitudinal direction intersecting with each other;
a processing mechanism, wherein the processing mechanism comprises a processing base, a spindle assembly, and a pressing member, wherein the processing base is mounted at the second transverse moving member, wherein the spindle assembly is movably connected to the processing base and configured to process a component, wherein the pressing member is movably connected to the processing base and configured to contact and engage with the component, the spindle assembly and the pressing member being capable of moving independently; and
an auxiliary tooling located at a side of the positioning mechanism in the second transverse direction and configured to fix the component,
wherein the processing mechanism further comprises:
a first driving member mounted at the processing base, wherein the first driving member comprises a first retractable portion, and wherein the pressing member is provided with a first connection portion at an outer circumferential surface of the pressing member, the first retractable portion being connected to the first connection portion and configured to drive the pressing member to move axially; and
a second driving member mounted at the processing base, wherein the second driving member comprises a second retractable portion, and wherein the spindle assembly is provided with a second connection portion at an outer circumferential surface of the spindle assembly, the second retractable portion being connected to the second connection portion to drive the spindle assembly to move axially.
wherein the second connection portion is disposed at an end portion of the first driving member close to the component, wherein the pressing member is located at a side of the second connection portion facing towards the component, and wherein a spindle of the spindle assembly passes through the pressing member,
wherein the processing base comprises a first base, a second base, and five branch chains, wherein:
the first base is connected to the second transverse moving member;
each of the five branch chains is connected to the first base via a first hinge with two intersecting rotational axes;
one of the five branch chains is connected to the second base via a second hinge; and
each of the other four branch chains of the five branch chains is connected to the second base via a third hinge with two intersecting rotational axes,
wherein each of the five branch chains comprises a branch chain driving member connected to the first hinge and a branch chain lead screw connected to the second hinge, the branch chain driving member being threadedly engaged with the branch chain lead screw and configured to drive the branch chain lead screw to extend and retract axially,
wherein the spindle assembly, the first driving member, and the second driving member are all arranged at the second base,
wherein, in an axial direction of the spindle assembly:
five first hinges are located at a same level;
the second hinge and two third hinges are located at a same level and connected to a lower part of the second base; and
the other two third hinges are located at a same level and connected to an upper part of the second base,
wherein, in a circumferential direction of the spindle assembly:
the second hinge and the two third hinges that are located at a lower level are evenly arranged at intervals; and
the other two third hinges are located at a higher level, and each of the other two third hinges is located between the second hinge and the two third hinge that are located at the lower level,
wherein the higher level refers to a larger distance between the hinge and the component in the axial direction of the spindle assembly, and the lower level refers to a smaller distance between the hinge and the component in the axial direction of the spindle assembly,
wherein the method comprises:
mounting the component at the auxiliary tooling;
controlling three-degree-of-freedom motion of the positioning mechanism, to position the spindle assembly of the processing mechanism opposite to the component;
controlling the spindle assembly to move relative to the processing base, to align a spindle of the spindle assembly with a to-be-processed point of the component;
controlling the pressing member to extend to press against a surface of the component; and
controlling the spindle assembly to feed axially, to realize a processing operation on the component,
wherein the method further comprises, prior to controlling the pressing member to extend to press against the surface of the component:
controlling the pressing member to extend and come into contact with the surface of the component;
detecting a normal direction of the to-be-processed point; and
controlling the pressing member to retract, and controlling the spindle assembly to move relative to the processing base, to allow an axial direction of the spindle assembly to coincide with the normal direction of the to-be-processed point, and allow the spindle to be aligned with the to-be-processed point,
wherein said detecting the normal direction of the to-be-processed point comprises:
the pressing member comprises a conical surface at a surface of the pressing member facing towards the component, the conical surface being provided with four distance detection members, wherein after the first driving member controls the pressing member to extend and come into contact with the surface of the component, the distance detection members at the pressing member begin to detect the distance to the to-be-processed point at the surface of the component. wherein three of the four distance detection members determine the normal direction of the to-be-processed point, and a remaining one of the four distance detection members verifies and calibrates the detected normal direction.

2-6. (canceled)

7. The control method according to claim 1, wherein:
the positioning base is provided with a first slide rail extending in the first transverse direction, the first slide rail being provided with two stop portions at two ends of the first slide rail in the first transverse direction, respectively; and
the first transverse moving member is provided with a first slide block at a bottom of the first transverse moving member, the first slide block being slidable along the first slide rail between the two stop portions.

8. The control method according to claim 1, wherein:
the first transverse moving member is provided with a mounting space extending in the longitudinal direction, the mounting space extending through the first transverse moving member in the second transverse direction;
the first transverse moving member is provided with a second slide rail on at least one side of the first transverse moving member in the second transverse direction, the second slide rail extending in the longitudinal direction, the longitudinal moving member passing through the mounting space and being slidably engaged with the second slide rail via a second slide block; and
the first transverse moving member is provided with a first motor and a first lead screw, wherein the first lead screw extends in the longitudinal direction and is threadedly engaged with the longitudinal moving member, wherein the first motor is connected to the first lead screw and configured to drive the first lead screw to rotate, and wherein the first lead screw rotates to drive the longitudinal moving member to move in the longitudinal direction.

9. The control method according to claim 1, wherein:
the longitudinal moving member and the second transverse moving member is slidably engaged with a third slide rail via a third slide block, the third slide rail extending in the second transverse direction; and
the longitudinal moving member is provided with a second motor and a second lead screw, wherein the second lead screw extends in the second transverse direction and is threadedly engaged with the second transverse moving member, wherein the second motor is connected to the second lead screw and configured to drive the second lead screw to rotate, and wherein the second lead screw rotates to drive the second transverse moving member to move in the second transverse direction.

10. The control method according to claim 1, wherein the auxiliary tooling and the positioning mechanism are arranged independently.

11-14. (canceled)
